(19) United States
(12) Patent Application Publication
(10) Pub. No.: US 2026/0118612 A1
(43) Pub. Date: Apr. 30, 2026

(54) DIAGONAL DIRECTIONAL COUPLER ELEVATOR

(71) Applicant: PsiQuantum, Corp., Palo Alto, CA (US)

(72) Inventors: Peter O. Weigel, Longwood, FL (US); Koen Alexander, Palo Alto, CA (US)

(21) Appl. No.: 19/019,245

(22) Filed: Jan. 13, 2025

Related U.S. Application Data
(63) Continuation of application No. PCT/US2023/070085, filed on Jul. 12, 2023.
(60) Provisional application No. 63/368,256, filed on Jul. 12, 2022.

(51) Int. Cl. G02B 6/43; G02B 6/12; G02B 6/122; G02B 6/42

(52) U.S. Cl. CPC G02B 6/43; G02B 6/12002; G02B 6/12004; G02B 6/1228; G02B 6/4283; G02B 6/4289; G02B 2006/12145

(57) ABSTRACT

A waveguide coupler includes a first waveguide layer including a first waveguide, a second waveguide layer including a second waveguide optically coupled to the first waveguide, and a dielectric layer between the first waveguide layer and the second waveguide layer in a first direction (e.g., vertical direction). A distance between the first waveguide and second waveguide in a second direction (e.g., a horizontal direction) that is perpendicular to the first direction is greater than zero, and has different values at two or more different sections of the waveguide coupler along a third direction (e.g., the light propagation direction).

### CROSS-REFERENCE TO RELATED APPLICATIONS

This patent application is a continuation of International Application No. PCT/US2023/070085, filed Jul. 12, 2023, entitled “DIAGONAL DIRECTIONAL COUPLER ELEVATOR,” which claims benefit of and priority to U.S. Provisional Patent Application No. 63/368,256, filed Jul. 12, 2022, entitled “DIAGONAL DIRECTIONAL COUPLER ELEVATOR,” the disclosures of which are assigned to the assignee hereof and are hereby incorporated by reference in their entireties for all purposes.

### BACKGROUND

Photonic integrated circuits can be used in many systems, such as quantum communication systems and optical quantum computing systems. These quantum mechanics-based systems are distinguished from “classical” systems by their reliance on quantum states, such as quantum bits (qubits). To achieve the desired functions and performance, a quantum mechanics-based system may integrate many passive and active photonic devices, modules, and subsystems into the same system. For example, an optical quantum computer may need to integrate various passive and active photonic integrated circuits and other optical and electrical components, such as waveguides, optical fibers, or other low-loss optical interconnects, control circuits, and classical processing units, into a same system, in order to reliably generate, manipulate (e.g., entangle), and detect hundreds, thousands, or even millions of qubits for computing and error corrections, while achieving the desired functions and performance. Photons may be transported from one component to another component in the system through one or more waveguides, where the photons may be coupled, for example, from one waveguide to another waveguide on a same or different layer.

### SUMMARY

Techniques disclosed herein relate generally to low-loss vertical interlayer waveguide couplers for coupling light from one waveguide layer to another waveguide layer. More specifically, disclosed herein are techniques for improving the coupling efficiencies between two adjacent waveguide layers using two waveguides that may have different widths and different horizontal distances between the two waveguides at different sections along the light propagation direction, where the two waveguides may not include small features that may be difficult to fabricate. Various inventive embodiments are described herein, including methods, processes, systems, devices, circuits, packages, modules, units, wafers, dies, networks, cells, and the like.

According to certain embodiments, a waveguide coupler may include a first waveguide layer including a first waveguide, a second waveguide layer including a second waveguide optically coupled to the first waveguide, and a dielectric layer between the first waveguide layer and the second waveguide layer in a first direction. A distance between the first waveguide and second waveguide in a second direction that is perpendicular to the first direction is greater than zero, and may have different values at two or more different sections of the waveguide coupler along a third direction that is perpendicular to the first direction and the second direction.

In some embodiments, a width of the first waveguide in the second direction may have different values at two or more different sections of the waveguide coupler along the third direction, and a width of the second waveguide in the second direction may have different values at two or more different sections of the waveguide coupler along the third direction. In some embodiments, a minimum width of the first waveguide and the second waveguide in the second direction may be equal to or greater than about 1 μm.

In some embodiments, the first waveguide may be bent with respect to the third direction at a first end of the waveguide coupler. A width of the second waveguide or the first waveguide at the first end of the waveguide coupler may be tapered along the third direction. In some embodiments, the second waveguide may be bent with respect to the third direction at a second end of the waveguide coupler. In some embodiments, a width of the first waveguide or the second waveguide at the second end of the waveguide coupler may be tapered along the third direction.

In some embodiments, the first waveguide layer and the second waveguide layer may have different thicknesses in the first direction. In some embodiments, the first waveguide layer and the second waveguide layer may both be in an optical backplane. In some embodiments, the first waveguide layer and the second waveguide layer may both be in a photonic integrated circuit die. In some embodiments, the first waveguide layer may be in an optical backplane, and the second waveguide layer may be in a photonic integrated circuit die bonded to the optical backplane. In some embodiments, the dielectric layer may include an oxide layer. In some embodiments, the first waveguide may include silicon nitride. In some embodiments, the first waveguide may include an electro-optically active material and may be coupled to an electro-optic switch. The electro-optically active material may include, for example, lithium niobate, various polymers, lead zirconate titanate, barium titanate, doped silicon, gallium phosphide, or a combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Aspects of the present disclosure are illustrated by way of example. Non-limiting and non-exhaustive aspects are described with reference to the following figures, wherein like reference numerals refer to like parts throughout the various figures unless otherwise specified.

FIG. 1A is a top view of an example of an optical module including a photonic integrated circuit die coupled to optical fibers according to certain embodiments.

FIG. 1B is a cross-sectional view of the example package shown in FIG. 1A according to certain embodiments.

FIG. 1C is another across-sectional view of the example package shown in FIG. 1 according to certain embodiments.

FIG. 2 is a simplified block diagram of an example of a quantum computing system according to some embodiments.

FIG. 3 illustrates an example of a subsystem for generating entangled quantum states (e.g., resource states or logical qubits) according to certain embodiments.

FIG. 4A is a top view of an example of a wafer-scale module including multiple EPIC die stacks on a handle wafer according to certain embodiments.

FIG. 4B illustrates an example of a system including multiple wafer-scale modules interconnected using optical fibers according to certain embodiments.

FIG. 5 is a cross-sectional view of an example of a wafer-scale module according to certain embodiments.

FIG. 6A illustrates an example of a photonic integrated circuit device according to certain embodiments.

FIG. 6B illustrates a portion of the example of the photonic integrated circuit device of FIG. 6A according to certain embodiments.

FIG. 6C illustrates another portion of the example of the photonic integrated circuit device of FIG. 6A according to certain embodiments.

FIG. 7A is a top view of an example of an interlayer waveguide coupler including tapered waveguides.

FIG. 7B is a cross-sectional view of the example of the interlayer waveguide coupler of FIG. 7A.

FIG. 8A is a top view of an example of an interlayer waveguide coupler according to certain embodiments.

FIGS. 8B-8D are cross-sectional views of the example of the interlayer waveguide coupler at different sections along the light propagation direction according to certain embodiments.

FIGS. 9A-9D illustrate an example of an interlayer waveguide coupler according to certain embodiments.

### DETAILED DESCRIPTION

Techniques disclosed herein relate generally to low-loss vertical interlayer waveguide couplers for coupling light from one waveguide layer to another waveguide layer. More specifically, disclosed herein are techniques for improving the coupling efficiencies between two adjacent waveguide layers using two waveguides that have different widths and different horizontal distances between the two waveguides at different sections along the light propagation direction, in order to reduce the total loss in a system (e.g., an optical quantum computing system) that may include many vertical interlayer waveguide couplers. The two waveguides may not include small features that may be difficult to fabricate as in tapered interlayer waveguide couplers, and thus may be more accurately fabricated to achieve the low coupling loss, such as equal to or less than about 10 mdB. Various inventive embodiments are described herein, including methods, processes, systems, devices, circuits, packages, modules, units, wafers, dies, networks, cells, and the like.

Many optical systems may integrate passive and active photonic integrated circuits and other optical and electrical components, such as waveguides or other low-loss optical interconnects, and passive and active devices made using waveguides. Photons may be transported within the optical system through the waveguides. In photonic integrated circuits, the waveguides and passive and active devices may be made in different layers for vertical integration. Therefore, vertical interlayer waveguide couplers may be needed to couple light from one layer to another layer. One example of the vertical interlayer waveguide coupler may include two waveguides on two waveguide layers, where the two waveguides may be center-aligned in a horizontal direction, and may be tapered in opposite directions and may include small features at ends of the tapering. To achieve a high coupling efficiency, the two waveguides may need to be close to each other and well aligned with each other, and the tapered waveguides may need to be fabricated with high accuracy (e.g., with small feature sizes), which can be difficult to achieve using existing processing technologies. In addition, the tapered coupling regions may need to be long, and thus the coupler may have a large footprint.

According to certain embodiments, a vertical interlayer waveguide coupler may include two waveguides on two adjacent waveguide layers, where the two waveguides may have different widths and different horizontal distances with respect to each other in different sections of the vertical interlayer waveguide coupler along the light propagation direction. The waveguides do not have very small feature sizes as in the vertical interlayer waveguide couplers that include aligned, tapered waveguides, and thus may be relatively easy to fabricate and achieve the desired dimensions (and hence lower loss). Furthermore, the coupler can have a shorter coupling region and a smaller footprint.

In some embodiments, the input section of the input waveguide and the output section of the output waveguide may be tapered to reduce reflections at the input section and the output section. The horizontal gap (distance) between the two waveguides may be adjusted to change the coupling strength and the dispersion of the coupler. For example, the horizontal gap (distance) between the two waveguides may be varied along the length of the coupling region to achieve a desired dispersion performance.

As used herein, a “qubit” (or quantum bit) refers to a quantum system with an associated quantum state that can be used to encode information. A quantum state can be used to encode one bit of information if the quantum state space can be modeled as a (complex) two-dimensional vector space, with one dimension in the vector space being mapped to logical value 0 and the other to logical value 1. In contrast to classical bits, a qubit can have a state that is a superposition of logical values 0 and 1. More generally, a “qudit” can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit. Qubits (or qudits) can be implemented in a variety of quantum systems. Examples of qubits include: polarization states of photons; presence of photons in waveguides; or energy states of atoms, ions, nuclei, or photons. Other examples may include other engineered quantum systems such as flux qubits, phase qubits, or charge qubits (e.g., formed from a superconducting Josephson junction); topological qubits (e.g., Majorana fermions); or spin qubits formed from vacancy centers (e.g., nitrogen vacancies in diamond). A physical qubit may be a physical device that behaves as a two-state quantum system. In one example, a qubit can be “dual-rail encoded” such that the logical value of the qubit is encoded by the occupation of one of two modes of the quantum system.

As used herein, a “resource state” refers to an entangled state of a number of qubits in a non-separable entangled state (which is an entangled state that cannot be decomposed into smaller separate entangled states). In various embodiments, the number of qubits of a resource state can be a small number (e.g., two or more, or any number up to about 20) or a larger number (as large as desired).

As used herein, a “logical qubit” refers to a physical or abstract qubit that has a long enough coherence time to be usable by quantum logic gates. A logical qubit may specify how a single qubit should behave in a quantum algorithm, subject to quantum logic operations by quantum logic gates. Due to issues such as stability, decoherence, fault tolerance, and scalability associated with a physical qubit that includes a single two-state quantum system, physical qubits may not be used to reliably encode and retain information for a sufficiently long period of time to be useful. Therefore, quantum error correction may need to be used to produce scalable quantum computers, where many physical qubits may be used to create a single, error-tolerant logical qubit. Depending on the error-correction scheme used and the error rates of each physical qubit, a single logical qubit may be formed using a large number (e.g., tens, hundreds, thousands, or more) of physical qubits. As used in the following sections, the term “qubit” generally refers to a physical qubit, whereas all references to logical qubits include the qualifier “logical.”

As used herein, a “quantum system” may include particles (such as atoms, ions, nuclei, and/or photons) or engineered quantum systems, such as flux qubits, phase qubits, or charge qubits (e.g., formed from a superconducting Josephson junction), topological qubits (e.g., majorana fermions), spin qubits formed from vacancy centers (e.g., nitrogen vacancies in diamond), qubits otherwise encoded in multiple quantum systems (e.g., Gottesman-Kitaev-Preskill (GKP) encoded qubits), entangled states of qubits, and the like.

As used herein, “fusion” (or “a fusion operation” or “fusing”) refers to a two-qubit entangling measurement. A “fusion gate” is a structure that receives two input qubits, each of which is typically part of an entangled state of qubits. The fusion gate may perform a projective measurement operation on the input qubits to produce either one (e.g., in “type I fusion”) or zero (e.g., in “type II fusion”) output qubit in a manner such that the initial two entangled states of qubits are fused into a single entangled state of qubits. Fusion gates are specific examples of a general class of two-qubit entangling measurements and are particularly suited for photonic architectures.

Several illustrative embodiments will now be described with respect to the accompanying drawings. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

An optical system, such as an optical quantum computing system or an optical quantum communication system, may integrate passive and active photonic integrated circuits and other optical and electrical components, such as optical fibers or other low-loss optical interconnects, control circuits, and processing units, into a same system to reliably generate, manipulate (e.g., entangle), and detect hundreds, thousands, or even millions of qubits for computing and error corrections.

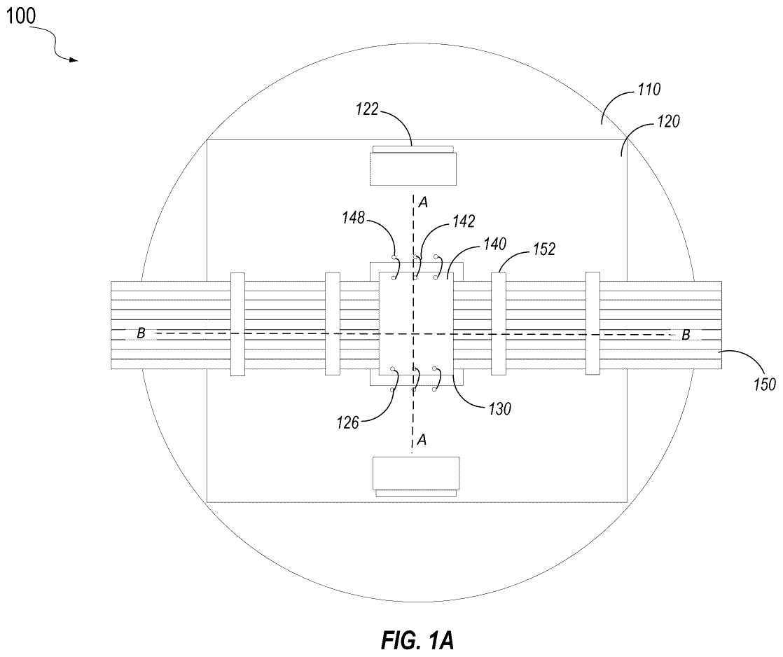

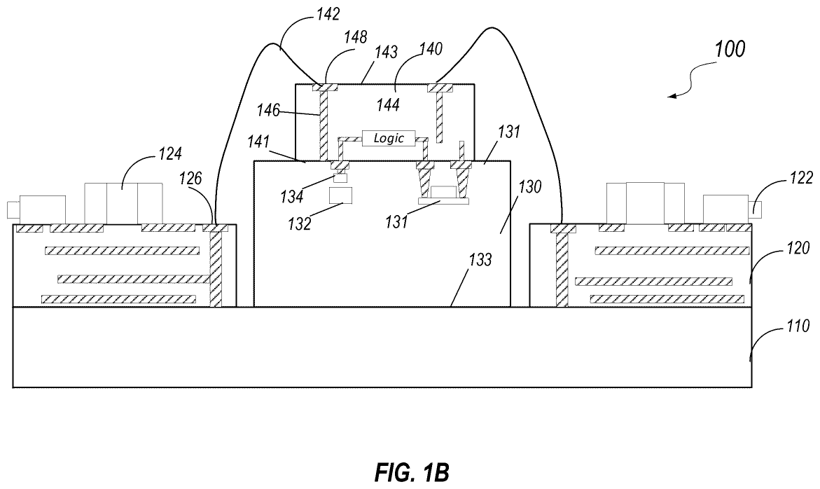

FIG. 1A is a top view of an example of an optical module 100 including a photonic integrated circuit (PIC) die 130 coupled to optical fibers 150 according to certain embodiments. In the illustrated example, optical module 100 includes PIC die 130, an electrical integrated circuit (EIC) die 140, a printed circuit board (PCB) 120, one or more electrical connectors 122, and optical fibers 150 on a silicon handle wafer 110. Even though FIG. 1A only shows one PIC/EIC (EPIC) die stack, multiple EPIC die stacks may be included in optical module 100. PCB 120 may be attached to silicon handle wafer 110, e.g., using an epoxy or through fusion bonding or hybrid bonding, depending on the material of PCB 120. In some embodiments, one or more PCBs 120 may be attached to silicon handle wafer 110 at different horizontal and/or vertical locations. An EPIC die stack includes EIC die 140 bonded face-to-face with PIC die 130 (e.g., by fusion bonding or hybrid bonding) such that the PICs may directly face the EICs and the substrates of PIC die 130 and EIC die 140 are on opposite sides of the EPIC die stack. The EPIC die stack may be bonded to silicon handle wafer 110 by, for example, fusion bonding. EIC die 140 may be electrically connected to PCB 120 through bonding wires 142, where the bonding pads and bonding wires may only be at the top (north) and bottom (south) sides of the EPIC die stack. The left (west) and right (east) sides of the EPIC die stack may be coupled with optical fibers 150, where optical fibers 150 may be attached to PCB 120 through harnesses 152. PCB 120 may also include electrical connectors 122 and some other electronic components, such as voltage regulators, power management ICs, decoupling capacitors, etc.

FIG. 1B is a cross-sectional view of optical module 100 along a line A-A shown in FIG. 1A according to certain embodiments. In the example shown in FIG. 1B, PCB 120 and the PIC/EIC die stack are bonded to a top surface of silicon handle wafer 110. PCB 120 may include multiple layers of interconnect traces or planes connected through vias. Electronic components, such as electrical connector 122 and decoupling capacitors 124 may be soldered on the top surface of PCB 120. PCB 120 may also include solder pads 126 on the top surface of PCB 120. The PIC/EIC die stack may include PIC die 130 and EIC die 140. PIC die 130 may include a back surface 133 bonded to silicon handle wafer 110. PIC die 130 may also include a front surface 131 that may include circuits or pads. EIC die 140 may include a back surface 143 that may include a redistribution layers and bonding pads 148. EIC die 140 may also include a front surface 141 that may include circuits or pads. EIC die 140 and PIC die 130 may be bonded face-to-face with each other such that front surface 131 of PIC die 130 and front surface 141 of EIC die 140 may directly face each other and the interconnections can be short. PIC die 130 may include waveguides 132 and 134, and other photonic integrated circuits, such as single photon generators, switches, waveguide couplers, and photodetectors 134. EIC die 140 may include some through-silicon vias (TSVs) 146 and control logic circuits 144. For example, a photodetector 134 may detect a single photon from waveguide 132, and send the detection result to control logic circuit 144, which may determine whether and how to tune waveguide 134 (e.g., to turn on or off an optical switch). Bonding pads 148 may be connected to control logic circuits 144 through TSVs, and may also be connected to solder pads 126 on PCB 120 through bonding wires 142.

FIG. 1C is another cross-sectional view of optical module 100 along a line B-B shown in FIG. 1A according to certain embodiments. In the example shown in FIG. 1C, in the B-B direction, optical fibers 150 may be attached to PCB 120 through harnesses 152. Optical fibers 150 may fit in V-grooves formed on PIC die 130, where the V-grooves may align with the waveguides on PIC die 130. Therefore, when assembled, the cores of optical fibers may align with corresponding cores of the waveguides on PIC die 130. Optical fibers 150 may be used to send photons into optical module 100, couple photons out of optical module 100, or loop photons from optical module 100 back into optical module 100. The photons may include pump photons, data communication signals (e.g., control signals), quantum states, and the like.

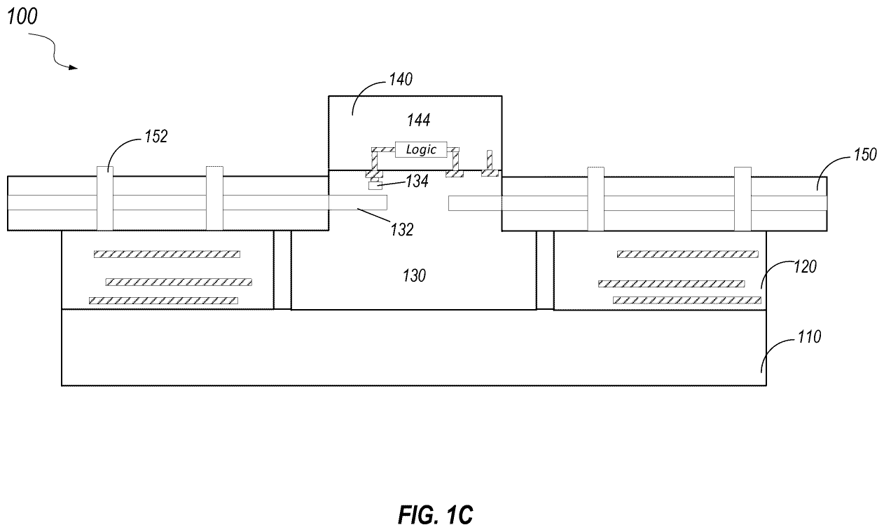

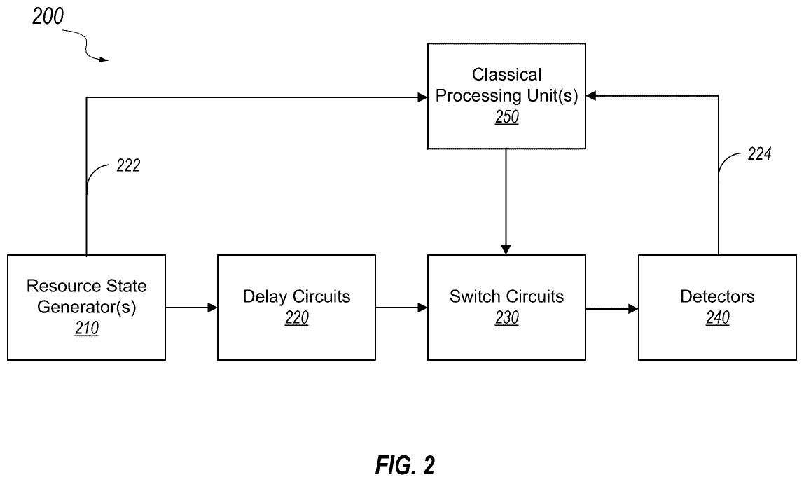

FIG. 2 is a simplified block diagram of an example of a quantum computing system 200 according to some embodiments. Quantum computing system 200 may include one or more optical modules 100 described above. Quantum computing system 200 may implement, for example, measurement-based quantum computing (MBQC) or fusion-based quantum computing (FBQC). Some embodiments of quantum computing system 200 may use photonic physical qubits to generate a fault-tolerant cluster state that can be used to represent logical qubits for MBQC, while other embodiments of quantum computing system 200 may generate measurement data reflecting entanglement structures for fault-tolerant FBQC. In the illustrated example, quantum computing system 200 may include resource state generator(s) 210, delay circuits 220, switch circuits 230, detectors 240, and one or more classical processing units 250.

Resource state generators 210 may include one or more resource state generators (RSGs). The RSGs may autonomously operate, with no data input needed. Each RSG may generate one resource state per clock cycle (which can be, e.g., shorter than about 1 ns, about 1 ns, or longer than about 1 ns). Each resource state may include multiple (e.g., 7 or 9) entangled physical qubits. The resource state can be output to delay circuits 220 at a rate of, for example, about n×N photons per clock cycle, where n is the number of qubits in each resource state and N is the number of RSGs. Resource state generators 210 can also send classical data output (e.g., indicating success or failure of various elements of the resource state generation process) to classical processing unit 250 via a data path 222. In some embodiments, resource state generators 210 can be maintained at cryogenic temperatures (e.g., 4 K). Delay circuits 220 can include optical fibers, other waveguides, optical memory, or other components to delay or store photons corresponding to particular qubits by appropriate delay times, such as 1 clock cycle, L clock cycles, and L² clock cycles, where L may be any integer number. Delay circuits 220 may not need to operate at cryogenic temperatures. Photons exiting delay circuits 220 can be delivered to switch circuits 230 via, for example, optical fibers, on-chip waveguides, or any other type of waveguides or optical interconnects.

Switch circuits 230 may include active switches and waveguides to perform mode coupling, mode swapping, phase shift, and other operations on the qubits. In various embodiments, switch circuits 230 may perform mode coupling operations associated with fusion operations as described below and/or basis selection operations associated with measurement of individual qubits. In some embodiments, switch circuits 230 may be dynamically reconfigurable in response to control signals from classical processing units 250, and thus quantum computing system 200 may perform different computations by reconfiguring switches in switch circuits 230. Switch circuits 230 may deliver output photons to detectors 240 via, for example, optical fibers, on-chip waveguides, or any other type of optical interconnects.

Detectors 240 may include photon detectors capable of detecting single or multiple photons. Each photon detector may be coupled to one waveguide and may generate an output (classical) signal indicating whether a photon was detected. In some embodiments, some or all detectors 240 may be capable of counting photons, and the output signal from each detector 240 may indicate the number of photons detected by the detector 240. In some embodiments, detectors 240 may operate at cryogenic temperatures. Detectors 240 may provide classical output signals indicating the number of photons, or binary signals indicating whether a photon was detected, to classical processing unit 250 via a signal path 224, such as optical fibers.

Classical processing unit 250 may be a classical computer system that is capable of communicating with resource state generator(s) 210, switch circuits 230, and detectors 240 using classical digital logic signals. In some embodiments, classical processing unit 250 may determine appropriate settings for switch circuits 230 based on a particular quantum computation (or program) to be executed. Classical processing unit 250 may receive feedback signals (e.g., measurement outcomes) from resource state generators 210 and detectors 240 and can determine the result of the computation based on the feedback signals. In some embodiments, classical processing unit 250 can use feedback signals to modify subsequent control signals sent to switch circuits 230. Operation of classical processing unit 250 may incorporate error correction algorithms and other techniques.

Quantum computing system 200 of FIG. 2 is illustrative, and variations and modifications are possible. Blocks shown separately can be combined, or a single block can be implemented using multiple distinct components. Resource state generator(s) 210, delay circuits 220, switch circuits 230, and detectors 240 can implement the circuits descried above and below for generating entanglement structures. For instance, delay circuits 220 may implement delay lines for resource state fusion, while switch circuits 230 may implement reconfigurable switches and mode couplers associated with reconfigurable fusion, and detectors 240 may implement destructive measurements associated with fusion operations. Quantum computing system 200 is just one example of a quantum computing system or another photonic system that can use the wafer-scale modules described herein. Those skilled in the art will appreciate that many different systems can be implemented using the wafer-scale modules that each include PIC or EPIC dies bonded to and optically coupled to an optical backplane having low-loss waveguides.

A qubit used in a quantum system may be physically realized using a pair of waveguides into which a single photon is introduced. Qubits can be operated upon using mode couplers (e.g., beam splitters), variable phase shifters, photon detectors, and the like. For instance, entanglement between two (or more) qubits can be created by providing mode couplers between waveguides associated with different qubits. As also described above, physical qubits may suffer from loss and/or noise. Consequently, relying on single physical qubits (e.g., a photon propagating in a pair of waveguides) when performing a quantum computation may result in an unacceptably high error rate. To provide fault tolerance, photonic quantum computers can be designed to operate on one or more logical qubits, where a logical qubit is a multi-qubit quantum system in an entangled state that enables error correction (also referred to herein as an error correcting code). For example, in some embodiments, the structure of the error correcting code can be represented as a graph in three dimensions. In the context of quantum computing, logical qubits can improve robustness by supporting error detection and error correction. Logical qubits may also be used in other contexts, such as quantum communication.

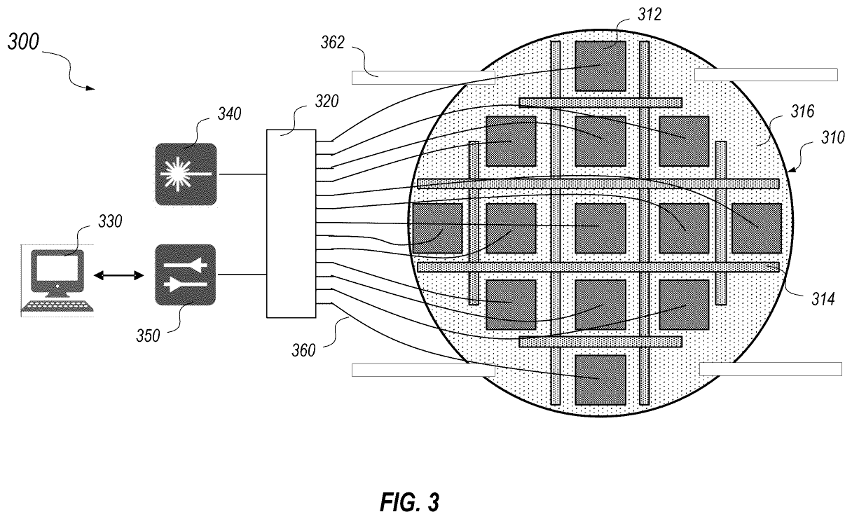

FIG. 3 illustrates an example of a subsystem 300 for generating entangled quantum states (e.g., resource states or logical qubits) according to certain embodiments. Subsystem 300 may include a wafer-scale module 310 that includes multiple EPIC die stacks 312 bonded to an optical backplane 316 (e.g., an optical interposer). Wafer-scale module 310 may be an example of optical module 100 or resource state generator 210. EPIC die stacks 312 may be manufactured and bonded to optical backplane 316 as described in details above and below. Wafer-scale module 310 may also include a plurality of PCBs 314 (e.g., an electrical backplane). The EIC dies in EPIC die stacks 312 may be electrically connected to PCBs 314 using, for example, wire bonding. EPIC die stacks 312 may be used to, for example, generate, manipulate, transport, and detect qubits or entangled states of qubits for optical quantum computing or optical quantum communication. For example, EPIC die stacks 312 may include single photon generators, mode couplers, fusion gates, beam splitters, switches, single photon detectors or multi-photon detectors, waveguides, delay lines, modulators, optical switches, ring oscillators, couplers, photodiode-based photodetectors for receiving data and timing signals, and the like, as described above and below. EPIC die stacks 312 may be optically connected together through optical fibers, optical waveguides in optical backplane 316, free-space optical interconnects, and/or other optical interconnects.

Wafer-scale module 310 may be connected to a distribution network 320 through optical fibers 360. Optical fibers 360 may be coupled to EPIC die stacks 312 through grating couplers (or edge couplers) and/or optical backplane 316. Distribution network 320 may be connected to one or more pump laser sources 340 and a control unit 330 (e.g., through an optical transceiver 350). Control unit 330 may include, for example, a classical computing system. In some embodiments, control unit 330 and/or distribution network 320 may be used to control two or more wafer-scale modules 310. Optical fibers 360 may be used to, for example, send pump laser pulses from pump laser sources 340 to EPIC die stacks 312 for single photon generation, send control data from control unit 330 and optical transceiver 350 to EPIC die stacks 312 (e.g., to control the switches), send measurement data from EPIC die stacks 312 to optical transceiver 350 and control unit 330, and the like.

In one example, each EPIC die stack 312 may include a single photon generator that includes waveguides, ring oscillators, interferometers, couplers, optical switches, WDM filters, single photon detectors, and the like that form multiple multiplexed photon pair sources to deterministically generate single photons through a nonlinear optical process (e.g., spontaneous four-wave mixing (SFWM), spontaneous parametric down-conversion (SPDC), second harmonic generation, etc.). In one embodiment, each photon pair source may include a micro-ring-based SFWM heralded photon source (HPS), where the detection of one photon of a pair of photons generated during the nonlinear process by a single photon detector (e.g., a superconductive nanowire single photon detector (SNSPD)) may herald the existence of the other photon in the pair that may be used to implement a qubit or generate an entangled resource state. Other classes of photon sources that do not use a nonlinear material may also be employed, such as those that employ atomic and/or artificial atomic systems (e.g., quantum dot sources, color centers in crystals, etc.). The operations of some photon sources may be non-deterministic (also sometimes referred to as “stochastic”) such that a given pump pulse may or may not produce a pair of photons. In such photon sources, coherent spatial and/or temporal multiplexing of several non-deterministic photon sources may be performed to increase the probability of having one photon in any given cycle. When the number of multiplexed non-deterministic photon sources is large, the probability of having one photon in any given cycle may be about 100%.

As illustrated in FIG. 3, wafer-scale module 310 may also be coupled to one or more optical fibers 362. The one or more optical fibers 362 may be used to transmit single photons, qubits, or entangled states of qubits between different wafer-scale modules 310 or may be used to loop qubits back to the same wafer-scale module after a delay. As described above and below, in some embodiments, optical fibers 362 may be coupled to waveguides in optical backplane 316 through low-loss couplers. In some embodiments, optical fibers 362 may be used as a long delay line for delaying the qubits to perform time-like resource state fusion operations. In some embodiments, optical fibers 362 may also be used for data communication or for transmitting pump laser pulses.

As described above, a plurality of EPIC die stacks may be bonded to a handle wafer, for example, by fusion bonding or oxide bonding, to form a wafer-scale module. The plurality of EPIC die stacks may be used to, for example, generate, manipulate, and detect qubits for optical quantum computing. In some embodiments, multiple wafer-scale modules may be connected through fiber cables, free-space optical interconnects, or other optical interconnects to form a subsystem or a system for larger scale quantum state generation, manipulation, and detection.

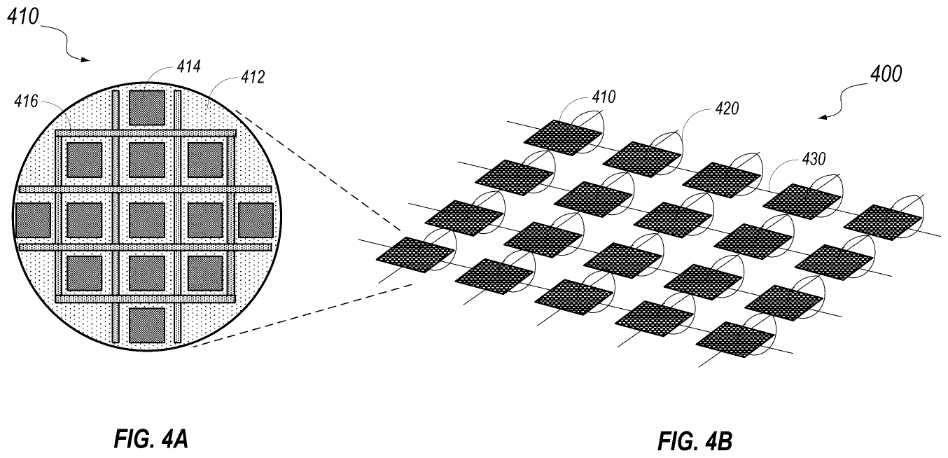

FIG. 4A is a top view of an example of a wafer-scale module 410 including multiple EPIC die stacks 414 on a handle wafer 412 according to certain embodiments. Wafer-scale module 410 may be an example of optical module 100, resource state generator 210, or subsystem 300. EPIC die stacks 414 may each include a PIC die and an EIC die, and may be manufactured and bonded to handle wafer 412 (e.g., including an optical backplane or another optical backplane) as described above. An EPIC die stack 414 may be optically connected to another EPIC die stack 414 through one or more optical fibers, one or more optical waveguides in the optical backplane, one or more free-space optical interconnects, or other optical interconnects. Wafer-scale module 410 may also include a plurality of PCBs 416. The EIC dies in EPIC die stacks 414 may be electrically connected to PCBs 416 using, for example, wire bonding. EPIC die stacks 414 may be used to, for example, generate, manipulate, and/or detect qubits (e.g., photonic qubits that employ one or more photons) or entangled states of qubits for optical quantum computing.

FIG. 4B illustrates an example of a system 400 including multiple wafer-scale modules 410 interconnected using optical fibers according to certain embodiments. As described above with respect to FIG. 4A, each wafer-scale module 410 may include multiple EPIC die stacks. Optical fibers may be used to provide inter-wafer and/or intra-wafer optical interconnects. For example, optical fibers 420 may be used to connect EPIC die stacks 414 on a same wafer-scale module 410, while optical fibers 430 may be used as interconnects between wafer-scale modules 410. System 400 may be used to perform, for example, qubit generation, manipulation, and/or detection at a larger scale.

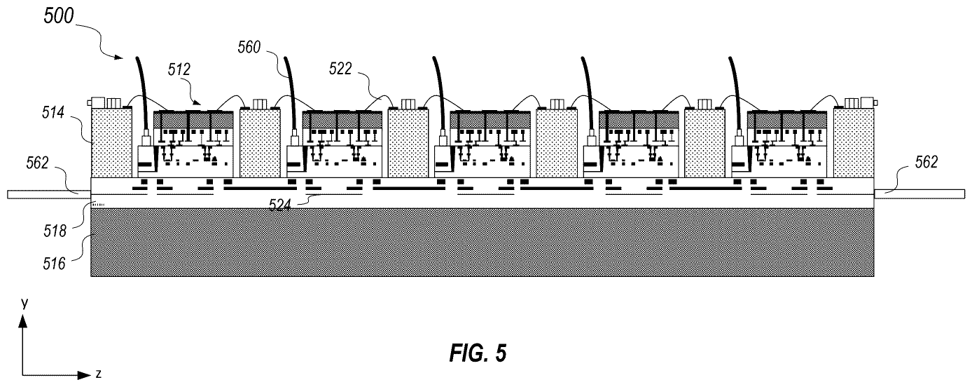

FIG. 5 is a cross-sectional view of an example of a wafer-scale module 500 (e.g., subsystem 300 or wafer-scale module 410) according to certain embodiments. As shown in FIG. 5, wafer-scale module 500 may include multiple EPIC die stacks 512, multiple PCBs 514, and optical fiber bundles. EPIC die stacks 512 may be optically connected to each other or other wafer-scale modules through an optical backplane 516, and may be electrically connected to PCBs 514 through bonding wires 522. Optical backplane 516 may include a dielectric layer 518 that includes one or more waveguide layers formed therein. The one or more waveguide layers may include low-loss waveguides 524 for transmitting, delaying, or storing single photons, qubits, qudits, resource states, or other entangled states. For example, waveguides 524 may include pairs of waveguides used to implement or transmit qubits and/or entangled qubits (e.g., resource states or larger entangled states of qubits). Photons may be coupled from one waveguide to another waveguide or from one waveguide layer to another waveguide layer through, for example, waveguide couplers. Photons may also be coupled from waveguides 524 in optical backplane 516 to waveguides in EPIC die stacks 512 through other waveguide layers and waveguide couplers in optical backplane 516 and/or EPIC die stacks 512. The waveguide couplers can be any type of waveguide coupler, e.g., adiabatic and/or evanescent waveguide couplers.

In the illustrated example, each EPIC die stack 512 may include a grating coupler for receiving pump light and/or data communication signals from an optical fiber 560. Optical fibers 562 may be coupled to waveguides 524 in optical backplane 516 through optical input/output ports that may include, for example, V-groove alignment structures and low-loss couplers, such as a tapered structure, a subwavelength grating, an edge coupler, and the like. Optical fibers 562 may be connected to other wafer-scale modules 500 or may be connected to different portions of wafer-scale module 500 (e.g., loop photons or qubits from wafer-scale module 500 back to wafer-scale module 500 after a delay).

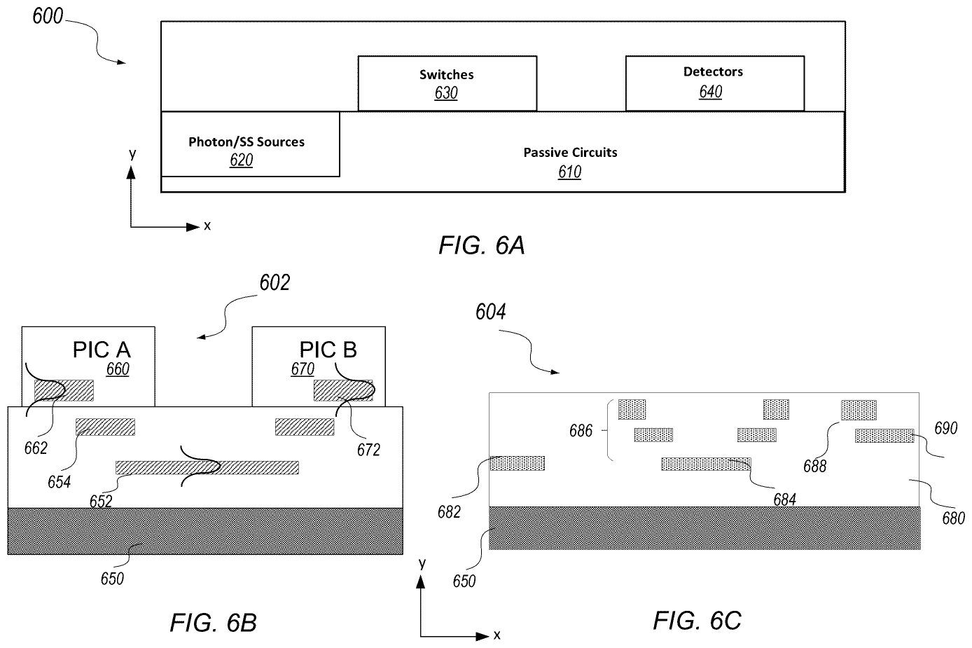

FIG. 6A illustrates an example of a photonic integrated circuit device 600 according to certain embodiments. PIC device 600 may include passive circuits 610, photon/seed state (SS) sources 620, switches 630, detectors 640, and other circuits, components, or structures. Passive circuits 610 may include, for example, waveguides, interferometers, couplers, WDM filters, beam splitters, delay lines, and the like. Photon/SS sources 620 may include, for example, ring oscillators, single photon generators (e.g., SFWM or SPDC single photon generators), mode couplers, fusion gates, delay lines, and the like. Switches 630 may include, for example, waveguides, modulators, heaters, electro-optic (Pockels) switches, piezoelectric switches such as a lead zirconate titanate (PZT) switch, control circuits, and the like. Detectors 640 may include single photon detectors (SNSPDs) or multi-photon detectors, such as photodiode-based photodetectors for receiving data and timing signals. In some embodiments, photonic integrated circuit device 600 may also include structures such as light scattering mitigation structures, thermal isolation structures, and the like. In some embodiments, PIC device 600 may include PIC dies bonded to an optical backplane (e.g., an optical interposer), where passive circuits 610, photon/SS sources 620, switches 630, detectors 640, and other structures may be formed in the PIC dies or the optical backplane. In some embodiments, passive circuits 610, photon/seed state sources 620, switches 630, detectors 640, and other structures may be fabricated in multiple layers on a same substrate.

FIG. 6B illustrates a portion 602 of the example of PIC device 600 of FIG. 6A according to certain embodiments. In the illustrated example, PIC device 600 may include an optical backplane that may include a substrate 650 (e.g., a silicon wafer) and multiple waveguide layers 652 and 654 formed on substrate 650 using multiple deposition and etching processes. Waveguide layers 652 and 654 may include, for example, SiN, and may be buried in one or more oxide layers. Waveguide layers 652 and 654 may have the same or different thicknesses and widths. The waveguide layers may be used to form, for example, routing waveguides, delay lines, waveguide pairs for implementing and transporting qubits and resource states, micro-ring resonators for generating photon pairs, switches, couplers, beam splitters (or other mode couplers), fusion gates, and the like.

FIG. 6B shows two PIC dies 660 and 670 bonded to the optical backplane. PIC dies 660 and 670 may include active and passive photonic integrated circuits formed thereon as described above. In the illustrated example, PIC die 660 (PIC A) may be optically coupled to PIC die 670 (PIC B) through multiple interlayer waveguide couplers formed by the optical backplane and the PIC dies. For example, PIC die 660 may include a waveguide on a waveguide layer 662 that may be coupled to a waveguide on waveguide layer 654 through an interlayer waveguide coupler formed by portions of the two waveguides. The waveguide on waveguide layer 654 may be optically coupled to a waveguide on waveguide layer 652 through another interlayer waveguide coupler. Similarly, PIC die 670 may include a waveguide on a waveguide layer 672 that may be coupled to a waveguide on waveguide layer 654 through an interlayer waveguide coupler formed by portions of the two waveguides. The waveguide on waveguide layer 654 may be optically coupled to the waveguide on waveguide layer 652 through another interlayer waveguide coupler. As such, light may be coupled between PIC dies 660 and 670 through multiple interlayer waveguide couplers and a waveguide (e.g., a delay line) on waveguide layer 652. Even though FIG. 6B shows two waveguide layers in the optical backplane, the optical backplane may include a single waveguide layer or more than two waveguide layers.

FIG. 6C illustrates a portion 604 of the example of photonic integrated circuit device 600 of FIG. 6A according to certain embodiments. In the illustrated example, the optical backplane may include substrate 650 and dielectric layers 680 deposited on substrate 650. Dielectric layers 680 may include various passive photonic integrated circuits formed therein. The passive photonic integrated circuits may include, for example, a coupler 682 for coupling light from an optical fiber into the optical backplane, a waveguide layer 684 (e.g., a SiN layer) that may include low-loss delay lines, a PIC-to-delay line coupler 686, a PIC-to-interposer coupler 688, routing waveguides 690, and the like. The couplers may include interlayer waveguide couplers for coupling light from one waveguide layer to another waveguide layer. The low-loss delay lines may be used to provide various delays, such as about 10-100 ps, about or greater than 1 ns, about 50 ns, or longer. In some embodiments, the low-loss delay lines in waveguide layer 684 and routing waveguides 690 may include pairs of waveguides for qubit interconnects. In some embodiments, the optical backplane may also include devices for dispersion compensation, polarization splitter/rotator, and the like. In some embodiments, the optical backplane may also include thermal isolation structures and/or scattering mitigation structures. In some embodiments, the optical backplane may also include phase shifters or phase stabilization circuits to improve the stability of qubits or entangled states of qubits propagating in qubit optical interconnects.

As shown and described above, a PIC device for optical quantum computing may include many interlayer waveguide couplers for optically coupling components and circuits formed on different layers and/or different dies. Therefore, in optical quantum computing systems where single photons are used for computing, it is desirable that the losses of the interconnects and couplers are low, such that the overall system loss is low and the error rate of the system is low.

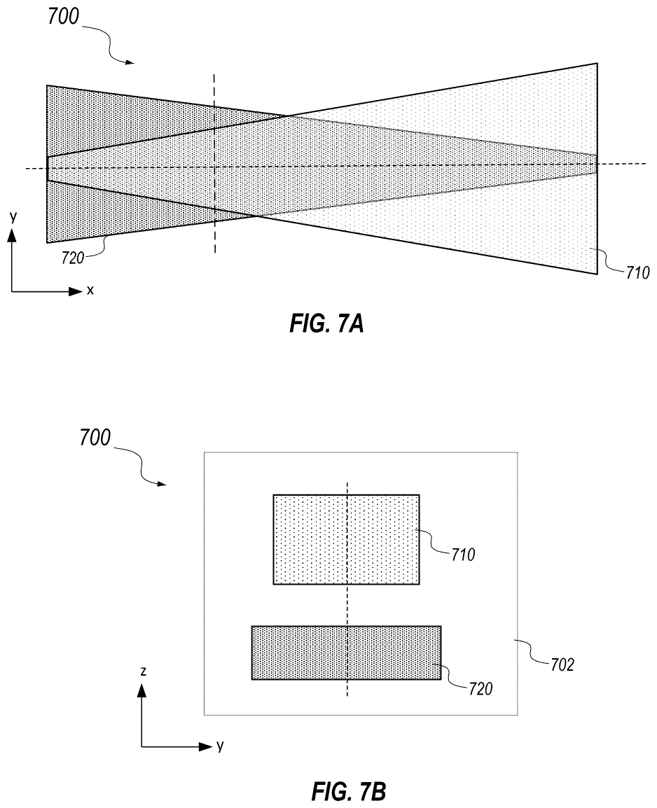

FIG. 7A is a top view of an example of an interlayer waveguide coupler 700 including aligned, tapered waveguides. FIG. 7B is a cross-sectional view of the example of interlayer waveguide coupler 700 of FIG. 7A. As illustrated, interlayer waveguide coupler 700 may include a first waveguide 710 and a second waveguide 720 that are on two different vertically arranged waveguide layers (at different z locations). First waveguide 710 and second waveguide 720 may be embedded in a dielectric material 702 (e.g., oxide). Light may propagate in first waveguide 710 and second waveguide 720 in substantially the +x or −x direction. The center of the two waveguides in a horizontal direction (e.g., y direction) may be aligned. To couple light from one waveguide layer to another waveguide layer, for example, from first waveguide 710 to second waveguide 720 (e.g., in the −x direction), first waveguide 710 may be tapered along the −x direction, where the width of first waveguide 710 may gradually reduce in the −x direction, while second waveguide 720 may be tapered along the +x direction where the width of second waveguide 720 may gradually increase in the −x direction. The widths of first waveguide 710 and second waveguide 720 may depend on, for example, refractive indices of first waveguide 710 and second waveguide 720 and the dielectric (e.g., oxide) materials surrounding the waveguides. In the illustrated example, first waveguide 710 and second waveguide 720 may be made of different materials (e.g., SiN, Si, lithium niobate, and barium titanate (BTO)), and thus may have different widths at the larger ends, different widths at the smaller ends, and/or different tapering angles (or tapering rates). In some embodiments, the tapering may be nonlinear.

As shown in FIG. 7A, the smaller ends of first waveguide 710 and second waveguide 720 may have small dimensions, such as less than about 1 μm, less than about 800 nm, or less than about 500 nm. To accurately fabricate continuously tapering waveguides with small ends, the minimum feature size of the processing technology may need to be small. However, many processing technologies and facilities may not achieve the desired minimum feature size. Therefore, interlayer waveguide coupler 700 made using existing processes that may not achieve the desire minimum feature size may not have the desired dimensions, and thus may have a high loss. In one example, the achievable minimum feature size of a fabrication process is about 700 nm, and the minimum coupling loss of an interlayer waveguide coupler 700 fabricated using the fabrication process may be about 500 mdB. In addition, as described above, the tapered coupling regions of first waveguide 710 and second waveguide 720 may need to be long, and the two waveguides may need to be close to each other and well aligned with each other, in order to achieve a better coupling efficiency.

According to certain embodiments, an interlayer waveguide coupler may include two waveguides on two adjacent waveguide layers, where the two waveguides may have different widths and different horizontal distances with respect to each other in different sections of the interlayer waveguide coupler along the light propagation direction. The waveguides do not have very small feature sizes (e.g., less than about 1 μm or smaller) and may not need to be continuously tapered as in the interlayer waveguide couplers with aligned, tapered waveguides shown in FIGS. 7A and 7B. Therefore, the waveguides may be relatively easy to fabricate and achieve the desired dimensions (and hence lower loss). For example, an interlayer waveguide coupler for coupling light between a SiN waveguide layer and an electro-optic (e.g., lithium niobate, various polymers, lead zirconate titanate, barium titanate, doped silicon, gallium phosphide, or a combination thereof) waveguide layer according to certain embodiments disclosed herein may have a coupling loss about 10 mdB, much lower than the 500 mdB loss of the aligned, tapered interlayer waveguide coupler 700 shown in FIGS. 7A and 7B. Furthermore, the coupler can have a shorter coupling region and a smaller footprint.

In some embodiments, the input section of the input waveguide and the output section of the output waveguide may be tapered to reduce reflections at the input section and the output section, improve the coupling strength, and reduce dispersion. The horizontal gap (distance) between the two waveguides may be adjusted to change the coupling strength and the dispersion of the coupler and reduce reflections. For example, the horizontal gap (distance) between the two waveguides may be varied along the length of the coupling region to achieve a desired dispersion performance.

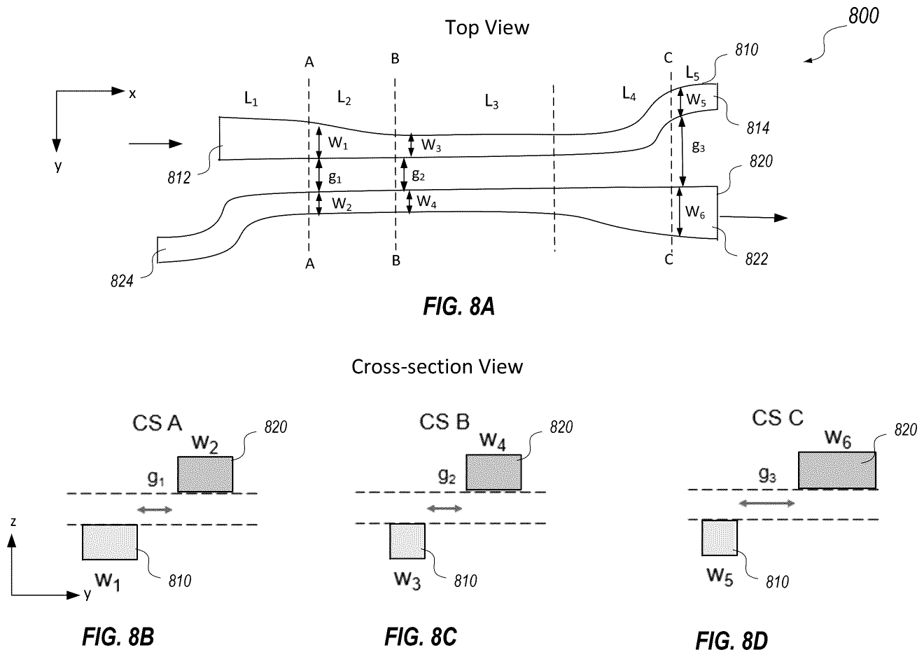

FIG. 8A is a top view of an example of interlayer waveguide coupler 800 according to certain embodiments. FIGS. 8B-8D are cross-sectional views of the example of interlayer waveguide coupler 800 at different sections along the light propagation direction according to certain embodiments. Interlayer waveguide coupler 800 may include a first waveguide 810 and a second waveguide 820 that are formed in two adjacent waveguide layers. As described above, first waveguide 810 and second waveguide 820 may include the same material or different materials. In one example, first waveguide 810 may include a core made of SiN, while second waveguide 820 may include a core made of an electro-optic material and may be coupled to an electro-optical switch (e.g., a BTO-based optical switch).

As shown in FIGS. 8A-8D, the thicknesses of first waveguide 810 and second waveguide 820 (in the z direction) and the vertical distance between first waveguide 810 and second waveguide 820 may remain constant in the light propagation direction (e.g., x direction). But the widths of first waveguide 810 and second waveguide 820 (in the y direction), and the distance between first waveguide 810 and second waveguide 820 in the y direction may be different in different sections of interlayer waveguide coupler 800.

For example, as shown in FIG. 8B, in the cross-section along a line AA, the width of first waveguide 810 may be W₁, the width of second waveguide 820 may be W₂, and the horizontal distance (in the y direction) between first waveguide 810 and second waveguide 820 may be g₁. As shown in FIG. 8C, in the cross-section along a line BB, the width of first waveguide 810 may be W₃, the width of second waveguide 820 may be W₄, and the horizontal distance (in the y direction) between first waveguide 810 and second waveguide 820 may be g In some embodiments, W₁ may be similar to or greater than W₃, W₂ may be similar to or smaller than W₄, and g₁ may be similar to, larger than, or smaller than g₂. In some embodiments, the width of second waveguide 820 and the horizontal separation of first waveguide 810 and second waveguide 820 may remain substantially constant in section L₂. In section L₁, second waveguide 820 may be adiabatically and diagonally bent at a port 824. In some embodiments, first waveguide 810 and/or second waveguide 820 may be tapered at a first end (e.g., in section L₁ and L₂) to reduce reflections at a port 812 or 824 of the interlayer waveguide coupler, as in the example shown in FIGS. 8A-8D. In some embodiments, second waveguide 820 and/or first waveguide 810 may be tapered at a second end (e.g., in section L₅) to reduce reflections at a port 822 or 814. In some embodiments, the widths and the horizontal separation of first waveguide 810 and second waveguide 820 may remain substantially constant in section L₃.

As shown in FIG. 8D, in the cross-section along a line CC, the width of first waveguide 810 may be W₅, the width of second waveguide 820 may be W₆, and the horizontal distance (in the y direction) between first waveguide 810 and second waveguide 820 may be g₃. W₅ may be similar to, larger than, or smaller than W₃, and W₆ may be larger than or similar to W₄. The end portion of first waveguide 810 may be bent diagonally at a port 814, and thus g₃ may be larger than g₂ and g₁. In some embodiments, waveguide 810 and/or waveguide 820 may be tapered in sections L₄ and L₅ of interlayer waveguide coupler 800 to reduce reflection at port 822 or 810 of interlayer waveguide coupler 800.

In some embodiments, the horizontal distance between first waveguide 810 and second waveguide 820 may be adjusted to change the coupling strength and the dispersion of the interlayer waveguide coupler. For example, the horizontal distance between first waveguide 810 and second waveguide 820 may be varied along the length of the coupling region to achieve a desired dispersion performance.

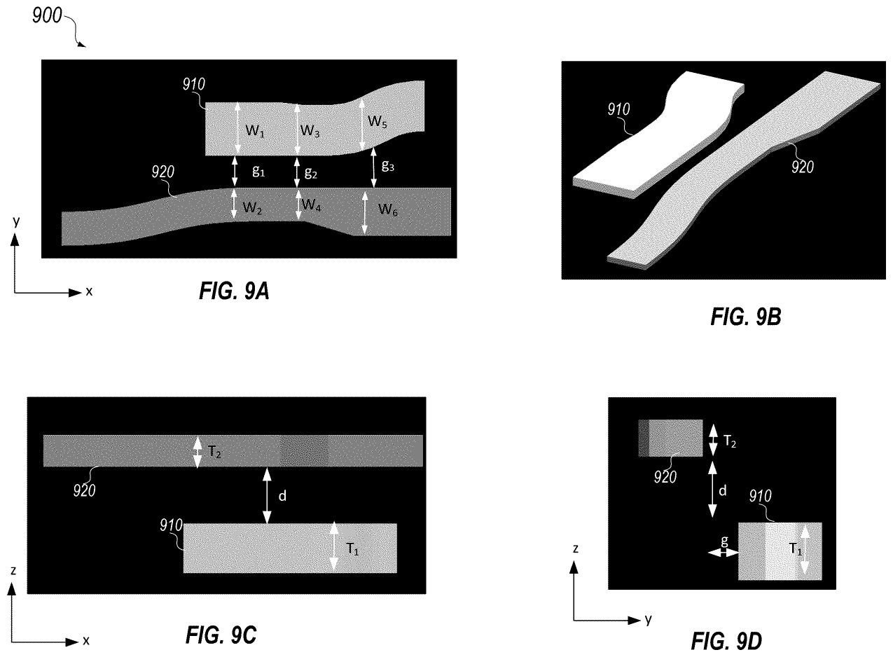

FIGS. 9A-9D illustrate an example of an interlayer waveguide coupler 900 according to certain embodiments. Interlayer waveguide coupler 900 may be an example of interlayer waveguide coupler 800, and may include a first waveguide 910 in a first waveguide layer and a second waveguide 920 in a second waveguide layer. FIG. 9A is a top view of interlayer waveguide coupler 900. FIG. 9B is a 3-dimensional view of interlayer waveguide coupler 900. FIG. 9C is a side view of interlayer waveguide coupler 900. FIG. 9D is a cross-sectional view of interlayer waveguide coupler 900.

FIG. 9A shows that the widths of first waveguide 910 and second waveguide 920 and the horizontal distance between first waveguide 910 and second waveguide 920 may be different at different sections of interlayer waveguide coupler 900. Some sections of the waveguides may be tapered. But no section of the waveguide has very small feature sizes (e.g., less than about 2 μm or 1 μm) as in interlayer waveguide coupler 700. FIG. 9C shows that the thicknesses and the vertical distance between first waveguide 910 and second waveguide 920 may remain contact in the coupling region. FIG. 9D shows the vertical distance and horizontal distance between first waveguide 910 and second waveguide 920 at a cross-section of interlayer waveguide coupler. As described above, interlayer waveguide coupler 900 may be relatively easy to fabricate accurately to achieve a low coupling loss.

The following are example embodiments:

Example 1: A waveguide coupler comprising: a first waveguide layer including a first waveguide; a second waveguide layer including a second waveguide optically coupled to the first waveguide; and a dielectric layer between the first waveguide layer and the second waveguide layer in a first direction, wherein a distance between the first waveguide and second waveguide in a second direction that is perpendicular to the first direction is greater than zero, and has different values at two or more different sections of the waveguide coupler along a third direction that is perpendicular to the first direction and the second direction.

Example 2: The waveguide coupler of Example 1, wherein: a width of the first waveguide in the second direction has different values at two or more different sections of the waveguide coupler along the third direction; and a width of the second waveguide in the second direction has different values at two or more different sections of the waveguide coupler along the third direction.

Example 3: The waveguide coupler of Example 1 or Example 2, wherein a minimum width of the first waveguide and the second waveguide in the second direction is equal to or greater than 1 μm.

Example 4: The waveguide coupler of any one of Examples 1-3, wherein the first waveguide is bent with respect to the third direction at a first end of the waveguide coupler.

Example 5: The waveguide coupler of any one of Examples 1-4, wherein a width of the second waveguide at the first end of the waveguide coupler is tapered along the third direction.

Example 6: The waveguide coupler of any one of Examples 1-5, wherein a width of the first waveguide at the first end of the waveguide coupler is tapered along the third direction.

Example 7: The waveguide coupler of any one of Examples 1-6, wherein the second waveguide is bent with respect to the third direction at a second end of the waveguide coupler.

Example 8: The waveguide coupler of any one of Examples 1-7, wherein a width of the first waveguide at the second end of the waveguide coupler is tapered along the third direction.

Example 9: The waveguide coupler of any one of Examples 1-8, wherein the first waveguide layer and the second waveguide layer have different thicknesses in the first direction.

Example 10: The waveguide coupler of any one of Examples 1-9, wherein the first waveguide layer and the second waveguide layer are both in an optical backplane.

Example 11: The waveguide coupler of any one of Examples 1-10, wherein the first waveguide layer and the second waveguide layer are both in a photonic integrated circuit die.

Example 12: The waveguide coupler of any one of Examples 1-11, wherein: the first waveguide layer is in an optical backplane; and the second waveguide layer is in a photonic integrated circuit die bonded to the optical backplane.

Example 13: The waveguide coupler of any one of Examples 1-12, wherein the dielectric layer includes an oxide layer.

Example 14: The waveguide coupler of any one of Examples 1-13, wherein the first waveguide includes silicon nitride.

Example 15: The waveguide coupler of any one of Examples 1-14, wherein the first waveguide includes an electro-optically active material and is coupled to an electro-optic switch.

Example 16: The waveguide coupler of any one of Examples 1-15, wherein the electro-optically active material includes lithium niobate, various polymers, lead zirconate titanate, barium titanate, doped silicon, gallium phosphide, or a combination thereof.

It will be apparent to those skilled in the art that substantial variations may be made in accordance with specific implementations. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, AAB, ABC, AABBCCC, and the like.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that the claimed subject matter is not limited to the particular examples disclosed, but that such claimed subject matter may also include all aspects falling within the scope of appended claims, and equivalents thereof.

What is claimed is:

1. A waveguide coupler comprising:
a first waveguide layer including a first waveguide;
a second waveguide layer including a second waveguide optically coupled to the first waveguide; and
a dielectric layer between the first waveguide layer and the second waveguide layer in a first direction, wherein a distance between the first waveguide and second waveguide in a second direction that is perpendicular to the first direction is greater than zero, and has different values at two or more different sections of the waveguide coupler along a third direction that is perpendicular to the first direction and the second direction.

2. The waveguide coupler of claim 1, wherein:
a width of the first waveguide in the second direction has different values at two or more different sections of the waveguide coupler along the third direction; and
a width of the second waveguide in the second direction has different values at two or more different sections of the waveguide coupler along the third direction.

3. The waveguide coupler of claim 1, wherein a minimum width of the first waveguide and the second waveguide in the second direction is equal to or greater than 1 μm.

4. The waveguide coupler of claim 1, wherein the first waveguide is bent with respect to the third direction at a first end of the waveguide coupler.

5. The waveguide coupler of claim 4, wherein a width of the second waveguide at the first end of the waveguide coupler is tapered along the third direction.

6. The waveguide coupler of claim 4, wherein a width of the first waveguide at the first end of the waveguide coupler is tapered along the third direction.

7. The waveguide coupler of claim 4, wherein the second waveguide is bent with respect to the third direction at a second end of the waveguide coupler.

8. The waveguide coupler of claim 7, wherein a width of the first waveguide at the second end of the waveguide coupler is tapered along the third direction.

9. The waveguide coupler of claim 1, wherein the first waveguide layer and the second waveguide layer have different thicknesses in the first direction.

10. The waveguide coupler of claim 1, wherein the first waveguide layer and the second waveguide layer are both in an optical backplane.

11. The waveguide coupler of claim 1, wherein the first waveguide layer and the second waveguide layer are both in a photonic integrated circuit die.

12. The waveguide coupler of claim 1, wherein:
the first waveguide layer is in an optical backplane; and
the second waveguide layer is in a photonic integrated circuit die bonded to the optical backplane.

13. The waveguide coupler of claim 1, wherein the dielectric layer includes an oxide layer.

14. The waveguide coupler of claim 1, wherein the first waveguide includes silicon nitride.

15. The waveguide coupler of claim 1, wherein the first waveguide includes an electro-optically active material and is coupled to an electro-optic switch.

16. The waveguide coupler of claim 15, wherein the electro-optically active material includes lithium niobate, various polymers, lead zirconate titanate, barium titanate, doped silicon, gallium phosphide, or a combination thereof.
